(19) United States
(12) Patent Application Publication
(10) Pub. No.: US 2023/0114235 A1
(43) Pub. Date: Apr. 13, 2023

(54) Location-Based NFT Minting and Distribution

(71) Applicant: Disney Enterprises, Inc., Burbank, CA (US)

(72) Inventors: Adam D. Eivy, Vashon, WA (US); Charles V. Pritchard, Seattle, WA (US); Dionysius Mavromatis, Kirkland, WA (US); Katharine S. Navarre, Los Angeles, CA (US); Christiaan A. Cokas, Chester, CT (US)

(21) Appl. No.: 17/962,393

(22) Filed: Oct. 7, 2022

Related U.S. Application Data
(60) Provisional application No. 63/253,981, filed on Oct. 8, 2021.

(51) Int. Cl. G06Q 20/36; H04L 9/32; G06T 19/00

(52) U.S. Cl. CPC G06Q 20/3672; H04L 9/3213; G06T 19/006; H04L 2209/60; G06Q 2220/00

(57) ABSTRACT

A system includes a hardware processor and a memory storing software code, the software code is executed to receive an assembly message for a plurality of users including first and second users to assemble at a same physical or virtual location, confirm that the first and second users are present at the same physical or virtual location, verify that each of those users is an owner of a respective NFT related to the assembly message, and generate a smart contract governing minting of variant NFTs. The software is further executed to mint, based on the smart contract, a first variant NFT based on the NFT of the first user and a second variant NFT based on the NFT of the second user, and distribute the first or second variant NFTs to the first user and the other of the first or second variant NFTs to the second user.

### RELATED APPLICATIONS

The present application claims the benefit of and priority to a pending Provisional Patent Application Ser. No. 63/253,981 filed on Oct. 8, 2021, and titled “Geolocation-Based NFT Minting and Distribution,” which is hereby incorporated fully by reference into the present application.

### BACKGROUND

Existing NFT minting and distribution platforms enable collectors to buy, sell, or trade NFTs at will, but are indifferent to the location of collectors, their social interactions, or the activities that they may be engaged in. As a result, conventional processes for minting and distributing NFTs to collectors fail to incentivize those NFT collectors to meet, whether in real life or virtually, in order to share their experiences as collectors or to gain additional benefits through socialization or cooperative endeavor.

### BRIEF DESCRIPTION OF THE DRAWINGS

FIG. 1 shows a system for performing location-based NFT minting and distribution, according to one implementation;

FIG. 2 shows a client device configured to mediate collection and transfer of ownership of NFTs, according to one implementation;

FIG. 3 shows a swimlane diagram depicting a process for performing location-based NFT minting and distribution, according to another implementation; and

FIG. 4 shows a flowchart presenting an exemplary method for performing location-based NFT minting and distribution, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The technology known as a non-fungible token (NFT) is allowing individual artists and companies to sell ownership rights to a digital asset, such as a file containing a photo or other image, video, audio, or any other desirable digital representation of a real or virtual object. An NFT is itself a digital asset in the form of a unit of data stored on a secure digital ledger, such as a blockchain for example, that certifies the contents of a digital file to be unique and therefore non-fungible. An NFT can be used to represent a digital content which is typically stored in and accessible via the cloud, and confer ownership of that digital content to an individual or entity. However, in contrast to traditional ownership rights, ownership of an NFT does not prevent others from accessing, or even copying, the digital content associated with the NFT. That is to say, an NFT confers ownership of digital content that is separate from copyright.

The present application discloses systems and methods for performing location-based NFT creation (hereinafter “minting”) and distribution that address and overcome the deficiencies in the conventional art. As stated above, existing NFT minting and distribution platforms enable collectors to buy, sell, or trade NFTs at will, but are indifferent to the location of collectors, their social interactions, or the activities that, they may engaged in. That is to say, NFT platforms today do not offer location-based minting and distribution. As a result, conventional processes for minting and distributing NFTs to collectors fail to incentivize those NFT collectors to meet, whether in real life or virtually, in order to share their experiences as collectors or to gain additional benefits through socialization or cooperative endeavor. By contrast, the present location-based NFT minting and distribution solution advantageously enables the rewarding of collectors for their presence at particular physical locations or virtual locations and their participation in specific events. In addition, the present location-based NFT minting and distribution solution can add value to NFTs by increasing their scarcity due to their physical location or virtual location specific availability. For example, a “legendary” or limited edition variant NFT may be minted and distributed as souvenirs exclusively to participants present at a particular physical location or virtual location, or due to their participation in a specific event or events.

It is noted that, as defined in the present application, the term “NFT asset” may refer to any digital asset having its ownership certified by an NFT. Examples of an NFT asset may include a digital file containing an image or images, video without audio, audio without video, or audio-video (AV) content, such as all or part of a television (TV) episode, movie, or video game, to name a few. In addition, or alternatively, in some implementations, an NFT asset may be or include a digital representation of persons, fictional characters, locations, objects, and identifiers such as brands and logos, for example, which populate a virtual reality (VR), augmented reality (AR), or mixed reality (MR) environment. Such digital representations may depict virtual worlds that can be experienced by any number of users synchronously and persistently, while providing continuity of data such as personal identity, user history, entitlements, possessions, payments, and the like. Moreover, in some implementations, an NFT asset may be a hybrid of traditional audio-video and fully immersive VR/AR/MR experiences, such as interactive video.

It is further noted that the term cryptocurrency wallet or digital wallet may refer to any secure software application assigned to a creator or owner of an NFT asset that stores the NFT credentials (e.g., public and private keys, certifying ownership of the NFT asset), and enables the NFT asset creator or owner to reassign, i.e., sell or otherwise transfer ownership of the NFT asset to another person or entity. It is also noted that the relationship between an NFT asset and a digital wallet is many-to-one rather than one-to-one. That is to say, in some implementations, the same digital wallet may store NFT credentials for each of multiple NFT assets. However, the NFT credentials of an NFT asset are uniquely present in only one digital wallet at a time.

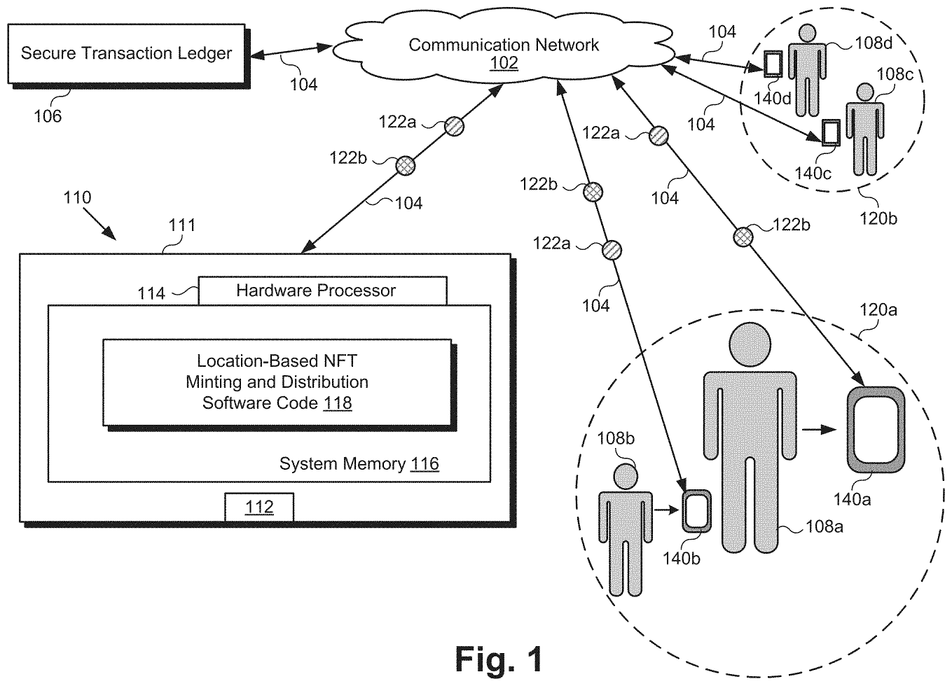

FIG. 1 shows system 110 configured to perform location-based NFT minting and distribution, according to one exemplary implementation. As shown in FIG. 1, system 110 includes NFT platform 111 having transceiver 112, hardware processor 114, and system memory 116 implemented as a computer-readable non-transitory storage medium. According to the present exemplary implementation, system memory 116 stores location-based NFT minting and distribution software code 118. In addition, FIG. 1 shows NFT collectors 108a and 108b present at real-world, physical location 120a, collectors 108c and 108d present at virtual location 120b, client devices 140a, 140b, 140c, and 140d utilized by respective collectors 108a, 108b, 108c, and 108d, secure transaction ledger 106, communication network 102 and network communication links 104 communicatively coupling system 110 to secure transaction ledger 106 and client devices 140a, 140b, 140c, and 140d. Also shown in FIG. 1 are variant NFT 122b distributed to client device 140a of collector 108a and variant NFT 122a distributed to client device 140b of collector 108b, via communication network 102 and network communication links 104.

With respect to the representation of system 110 shown in FIG. 1, it is noted that although location-based NFT minting and distribution software code 118 is depicted as being stored in system memory 116 for conceptual clarity, more generally, system memory 116 may take the form of any computer-readable non-transitory storage medium. The expression “computer-readable non-transitory storage medium,” as used in the present application, refers to any medium, excluding a carrier wave or other transitory signal that provides instructions to hardware processor of a computing platform, such as hardware processor 114 of NFT platform 111. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts location-based NFT minting and distribution software code 118 as being entirely located in a single instance of system memory 116, that representation is also merely provided as an aid to conceptual clarity. More generally, system 110 may include one or more computing platforms, such as computer servers for example, which may be co-located, or may form an interactively linked but distributed system, such as a cloud-based system, for instance. As a result, hardware processor 114 and system memory 116 may correspond to distributed processor and memory resources of system 110. Thus, it is to be understood that various software modules of location-based NFT minting and distribution software code 118 may be stored remotely from one another within the distributed memory resources of system 110.

Hardware processor 114 may include multiple hardware processing units, such as one or more central processing units, one or more graphics processing units, one or more tensor processing units, one or more field-programmable gate arrays (FPGAs), and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of NFT platform 111, as well as a Control Unit (CU) for retrieving programs, such as location-based NFT minting and distribution software code 118, from system memory 116, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, NFT platform 111 may correspond to one or more web servers, accessible over a packet-switched network such as the Internet, for example. Alternatively, NFT platform 111 may correspond to one or more computer servers supporting a private wide area network (WAN), local area network (LAN), or included in another type of limited distribution or private network. However, in some implementations, system 110 may be implemented virtually, such as in a data center. For example, in some implementations, system 110 may be implemented in software, or as virtual machines. Moreover, in some implementations, communication network 102 may be a high-speed network suitable for high performance computing (HPC), for example a 10 GigE network or an Infiniband network.

Transceiver 112 of system 110 may be implemented as a wireless communication unit configured for use with one or more of a variety of wireless communication protocols. For example, transceiver 112 may be implemented as a fourth generation (4G) wireless transceiver, or as a 5G wireless transceiver. In addition, or alternatively, transceiver 112 may be configured for communications using one or more of Wireless Fidelity (Wi-Fi), Worldwide Interoperability for Microwave Access (WiMAX), Bluetooth, Bluetooth low energy, ZigBee, radio-frequency identification (RFID) near-field communication (NFC), and 60 GHz wireless communications methods.

System 110 may be configured to create or “mint” NFTs, to mint and warehouse NFTs, or to distribute or warehouse NFTs minted by others. Secure transaction ledger 106 may take the form of a public or private secure transaction ledger. Examples of such secure transaction ledgers may include Blockchain, Hashgraph, Directed. Acyclic Graph (DAG), and Holochain ledgers, to name a few. In use cases in which secure transaction ledger 106 is a blockchain ledger, it may be advantageous or desirable to implement secure transaction ledger 106 to utilize a consensus mechanism having a proof-of-stake (PoS) protocol, rather than the more energy intensive proof-of-work (PoW) protocol. Although secure transaction ledger 106 is shown to be remote from system 110 in FIG. 1, such as a cloud-based or distributed secure transaction ledger, that implementation is merely exemplary. In other implementations, secure transaction ledger 106 may be stored in system memory 116 and may be controlled by system 110.

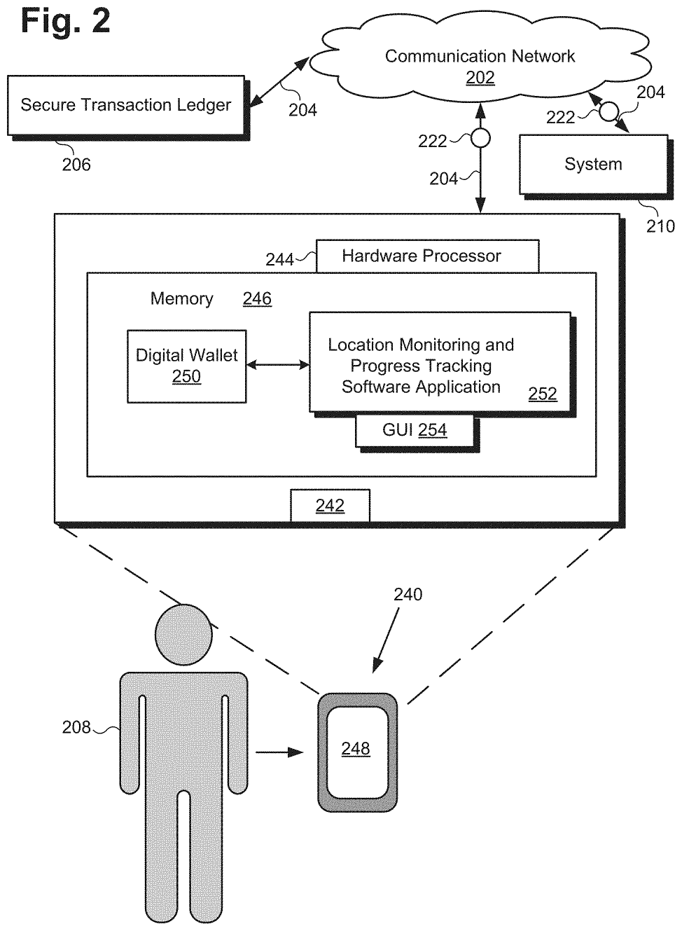

FIG. 2 shows client device 240 of collector 208, configured to mediate collection and transfer of ownership of NFTs, such as collection of variant NFT 222 for example, according to one implementation. As shown in FIG. 2, client device 240 includes transceiver 242, hardware processor 244, display 248, and memory 246 implemented as a computer-readable non-transitory storage medium storing digital wallet 250 and location monitoring and progress tracking software application 252 providing GUI 254. Also shown in FIG. 2 are system 210, communication network 202, network communication links 204, and secure transaction ledger 206.

Although client device 240 is shown as a smartphone in FIG. 2 that representation is provided merely as an example as well. More generally, client device 240 may be any suitable mobile or stationary computing device or system that implements data processing capabilities sufficient to provide GUI 254, support connections to communication network 202, and implement the functionality ascribed to client device 240 herein. For example, in other implementations, client device 240 may take the form of a desktop computer, laptop computer, tablet computer, smart TV, a smart wearable device, such as a smartwatch for example, or an AR or VR device.

Transceiver 242 may be implemented as a wireless communication unit configured for use with one or more of a variety of wireless communication protocols. For example, transceiver 242 may be implemented as a 4G wireless transceiver, or as a 5G wireless transceiver. In addition, or alternatively, transceiver 242 may be configured for communications using one or more of Wi-Fi, WiMAX, Bluetooth, Bluetooth low energy, ZigBee, RFID, NFC, and 60 GHz wireless communications methods.

With respect to display 248 of client device 240, display 248 may be physically integrated with client device 240 or may be communicatively coupled to but physically separate from client device 240. For example, where client device 240 is implemented as a smartphone, laptop computer, or tablet computer, display 248 will typically be integrated with client device 240. By contrast, where client device 240 is implemented as a desktop computer, display 248 may take the form of a monitor separate from client device 240 in the form of a computer tower. Furthermore, display 248 of client device 240 may be implemented as a liquid crystal display (LCD), a light-emitting diode (LED) display, an organic light-emitting diode (OLED) display, a quantum dot (QD) display, or any other suitable display screen that performs a physical transformation of signals to light.

Location monitoring and progress tracking software application 252 may be configured to initiate a secure and authorized communication session in order to use transceiver 242 to receive or transmit Global Positioning System (GPS) data or other location data in the form of Near-Field Communication (NFC) data, Bluetooth or Bluetooth LE data, or radio-frequency identification (RFID) data, as well as to track the progress of an ongoing activity, such as a quest, that collector 208 may be participating in.

According to the exemplary implementation shown in FIG. 2, digital wallet 250 can store NFT(s) on client device 240. However, in other implementations, digital wallet 250 may not be resident on client device 240, but may be a virtual wallet remote from client device 240, such as a cloud-based virtual wallet accessible to client device 240 via communication network 202 and network communication links 204. In yet other implementations, digital wallet 250 may be a hardware cryptocurrency wallet, such as a Ledger Nano S® device or the like.

System 210, communication network 202, network communication links 204, and secure transaction ledger 206 correspond respectively in general to system 110, communication network 102, network communication links 104, and secure transaction ledger 106, in FIG. 1. Thus, system 210, communication network 202, network communication links 204, and secure transaction ledger 206 may share any of the characteristics attributed to respective system 110, communication network 102, network communication links 104, and secure transaction ledger 106 by the present disclosure, and vice versa.

Moreover, collector 208, in FIG. 2, corresponds in general to any one or all of collectors 108a, 108b, 108c, and 108d, in FIG. 1, while client device 240 corresponds in general to any or all of client devices 140a, 140b, 140c, and 140d. Thus, collectors 108a, 108b, 108c, and 108d may share any of the characteristics attributed to collector 208 by the present disclosure, and vice versa, while client devices 140a, 140b, 140c, and 140d may share any of the characteristics attributed to client device 240, and vice versa. That is to say, although not shown in FIG. 1, each of client devices 140a, 140b, 140c, and 140d may include features corresponding respectively to transceiver 242, hardware processor 244, and memory 246 storing digital wallet 250, location monitoring and progress tracking software application 252 providing GUI 254, and display 248.

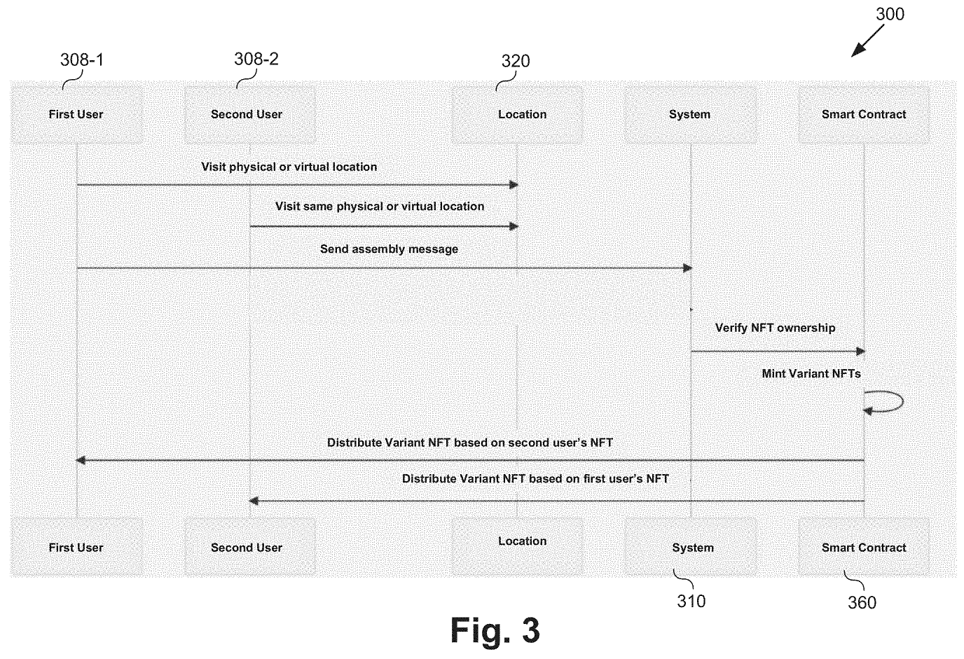

FIG. 3 shows swimlane diagram 300 of a process for performing location-based NFT minting and distribution, according to one implementation. Swimlane diagram 300 identifies first user 308-1, second user 308-2, location 320, system 310, and smart contract 360. It is noted that first user 308-1 corresponds in general to any of collectors 108a, 108c, or 208 shown variously in FIGS. 1 and 2. Thus, first user 308-1 may share any of the characteristics attributed to collectors 108a, 108c, and 208 by the present disclosure, and vice versa. In addition, second user 308-2 corresponds in general to any of collectors 108b, 108d, or 208 as also shown variously in FIGS. 1 and 2. Consequently, second user 308-2 may share any of the characteristics attributed to collectors 108b, 108d, and 208 by the present disclosure, and vice versa. Moreover, system 310 corresponds respectively in general to system 110/210 in FIGS. 1/2. That is to say, system 310 may share any of the characteristics attributed to system 110/210 by the present disclosure, and vice versa. With respect to first user 308-1 and second user 308-2, it is noted that although FIG. 3 depicts two users, first and second users 308-1 and 308-2 are merely representative of a plurality of users that includes first user 308-1 and second user 308-2 but may number more than two users.

It is also noted that location 320 corresponds in general to either of locations 120a or 120b, in FIG. 1. In other words, in various implementations, location 320 may be a real-world, physical location or a virtual location. In implementations in which location 120a/320 is a physical location, physical location 120a/320 may be the entire limits of a city, a recreation or resort property, a theme park or other entertainment venue, a hotel, a cruise ship, or the immediate vicinity, e.g., within ten feet or any other predetermined distance, of a physical object or coordinate (e.g., latitude and longitude). In implementations in which location 120b/320 is a virtual location, virtual location 120b/320 may be a virtual venue of an interactive video environment, which, in some implementations, may be configured to provide one or more of a VR, AR, or MR experience to first user 308-1 and second user 308-2. For example, virtual location 120b/320 may be or include a digital representation of a location including persons, fictional characters, objects, and identifiers such as brands and logos, for example, which populate a VR, AR, or MR environment. Such a digital representation may depict a virtual world that can be experienced by any number of users synchronously and persistently, while providing continuity of data such as personal identity, user history, entitlements, possessions, payments, and the like.

According to the exemplary process outlined in FIG. 3, first user 308-1 and second user 308-2 are present at the same location, i.e., location 320, at the same time. In implementations in which location 320 is a physical location, the concurrent presence of first user 308-1 and second user 308-2 at location 320 may be confirmed to an arbitrary level of precision using one or more of GPS data, RFID recognition, NFC recognition, or Bluetooth LE communications, to name a few examples. Alternatively, or in addition, location 320 may include a display showing a Quick Response (QR) code that cycles every few seconds, or over any other predetermined time period. In those implementations, and referring to FIGS. 1 and 2 in combination with FIG. 3, first user 308-1 and second user 308-2 could use respective client devices 140a/140c/240 and 140b/140d/240 to scan such a QR code and transmit it to system 110/210/310. As yet another alternative, or in addition, first user 308-1 and second user 308-2 may utilize an authenticator application, such as the Microsoft® Authenticator application for example, which may be supported by client devices 140a/140c/240 and 140b/140d/240, or may be shown on a display present at physical location 120a/320. The authenticator application may provide a pin number that cycles every few seconds, or over any other predetermined time period. In those implementations, first user 308-1 and second user 308-2 could enter that pin number into respective client devices 140a/140c/240 and 140b/140d/240 for transmission to system 110/210/310. Receipt by system 110/210/310 of the same QR code or pin number from each of client devices 140a/140c/240 and 140b/140d/240 verifies the concurrent present of collectors 308a and 308b at physical location 120a/320.

Analogously, and continuing to refer to FIGS. 1, 2, and 3 in combination, in implementations in which location 320 is a virtual location, the concurrent presence of first user 308-1 and second user 308-2 at virtual location 120b/320 may be confirmed using cookies or other tracking tokens employed by virtual location 120b/320. Alternatively, or in addition, virtual location 120b/320 may include a digital representation of a display showing a QR code that cycles every few seconds, or over any other predetermined time period. In those implementations, first user 308-1 and second user 308-2 could use respective client devices 140a/140c/240 and 140b/140d/240 to capture such a QR code and transmit it to system 110/210/310. As yet another alternative, or in addition, first user 308-1 and second user 308-2 may utilize an authenticator application, such as the Microsoft® Authenticator application for example, which may be supported by client devices 140a/140c/240 and 140b/140d/240, or may be shown on a digital representation of a display present at virtual location 120b/320. The authenticator application may provide a pin number that cycles every few seconds, or over any other predetermined time period. In those implementations, first user 308-1 and second user 308-2 could enter that pin number into respective client devices 140a/140c/240 and 140b/140d/240 for transmission to system 110/210/310. Receipt by system 110/210/310 of the same QR code or pin number from each of client devices 140a/140c/240 and 140b/140d/240 verifies the concurrent present of collectors 308a and 308b at virtual location 120b/320.

In a use cases in which first user 308-1 or second user 308-2 owns more than one NFT meeting a specific criterion, that user may select a qualifying NFT the own as a basis for minting a variant NFT. For example, if the criterion for receiving a variant NFT is ownership of an NFT associated with a particular movie franchise, and first user 308-1, for instance, has multiple NFTs from that franchise in his/her wallet, first user 308-1 may be prompted, via GUI 254, to select one or more of those NFTs to serve as the basis for one or more variant NFTs. That is to say, hardware processor 244 of client device 140a/140c/240 may execute location monitoring and progress tracking software application 252 to prompt first user 308-1 via GUI 254. Alternatively, in some implementations, location monitoring and progress tracking software application 252, executed by hardware processor 244, may select a qualifying NFT for variant minting from among multiple qualifying NFTs owned by first user 308-1 in an automated process.

Continuing to refer to FIGS. 1, 2, and 3 in combination, according to the implementation represented in FIG. 3, once present at location 120a/120b/320, one or more users who wish to interact with one another and receive an NFT benefit, such as one or both of first and second users 308-1 and 308-2, may transmit an “assembly” message to system 110/210/310, in response to which hardware processor 114 of system 110/210/310 may execute location-based NFT minting and distribution software code 118 to generate smart contract 360 linking those collectors and enabling the minting and distribution of variant NFTs. As a specific example, let location 120a/120b/320 be a physical or virtual venue devoted to a particular movie franchise, and let first and second users 308-1 and 308-2 each be owners of a different NFT associated with the movie franchise, for example, NFTs of different characters in the same movie franchise.

It is noted that although the present description of location-based NFT minting and distribution refers to the assembly message as being transmitted or “sent” by one or more of first user 308-1 or second user 308-2, that use case is provided merely by way of example. In other use cases, the assembly message may be sent by one or more of first user 308-1, second user 308-2, a creator of a respective NFT owned by each of first user 308-1 and second user 308-2, or a distributor of at least one of the respective NFTs owned by first user 308-1 or second user 308-2.

In the exemplary use case described above, and as shown by FIG. 3, hardware processor 114 of system 110/210/310 may execute location-based NFT minting and distribution software code 118 to mint, based on smart contract 360, variant NFT 122a/222 of the NFT owned by first user 308-1, to mint variant NFT 122b/222 of the NFT owned by second user 308-2, and to distribute variant NFT 122a/222 to second user 308-2, i.e., distribute a variant of the NFT owned by first user 308-1 to second user 308-2, and to distribute variant NFT 122b/222 to first user 308-1, i.e., distribute a variant of the NFT owned by second user 308-2 to first user 308-1, as rewards for participating in the assembly at location 320. Alternatively, or in addition, in some implementations, hardware processor 114 of system 110/210/310 may execute location-based NFT minting and distribution software code 118 to mint, based on smart contract 360, variant NFT 122a/222 of the NFT owned by first user 308-1, to mint variant NFT 122b/222 of the NFT owned by second user 308-2, and to distribute variant NFT 122a/222 to first user 308-1, i.e., distribute a variant of the NFT already owned by first user 308-1 to first user 308-1, and to distribute variant NFT 122b/222 to second user 308-2, i.e., distribute a variant of the NFT already owned by second user 308-2 to second user 308-2 as rewards for participating in the assembly at location 120a/120b/320. It is noted that although the exemplary use case described above, variant NFTs 122a/222 and 122b/222 are different variant NFTs, in other implementations, variant NFTs 122a/222 and 122b/222 may be substantially identical, i.e., variant NFT 122a/222 may be a replication of variant NFT 122b/222, or vice versa.

It is noted that the expression “variant NFT” refers to an NFT corresponding to an NFT asset having one or more modified or enhanced features relative to the NFT asset identified by the NFT to which the variant NFT is compared. As a specific example, where an NFT owned by first user 308-1 or second user 308-2 corresponds to an image of a movie character, variant NFT 122a/222 or 122b/222 may identify the same movie character depicted as having one or more of a different costume, different coloring, possessing different accessories, framed against a different background environment, wearing a different expression, or stamped with a limited release number, date, time, or location identifier, to name a few examples. Alternatively, or in addition, in some implementations, variant NFT 122a/222 or 122b/222 may include metadata entitling its recipient, e.g., first user 308-1 or second user 308-2, to enjoy one or more of a VR, AR, or MR experience at location 120a/120b/320 or another venue.

It is noted that variant NFTs 122a/222 and 122b/222 are typically independent of the original NFTs upon which they are based. As a result, variant NFTs 122a/222 and 122b/222 can usually be transferred independently of those original NFTs. Nevertheless, in some use cases, smart contract 360 can tie a variant NFT to its original NFT and require that they be transferred together. Moreover, in some implementations, the original NFT may be revoked, or “burned,” and the variant NFT may be reminted as a descendent upgrade of the original. For example, where a collector owns an NFT of character A from a movie franchise, that NFT may be revoked and the collector may receive a newly minted variant NFT of character A and another character B from the same franchise.

In some use cases, first and second users 308-1 and 308-2 may be required to join the assembly at location 120a/120b/320 within a specified present or future time window. Moreover, in some use cases, first and second users 308-1 and 308-2 must be present owners of an NFT relevant to location 120a/120b/320 in order to receive a variant NFT as a reward. In still other use cases, first user 308-1 may be engaged in a collaborative quest requiring that second user 308-2 visit location 120a/120b/320 before one or more of variant NFTs 122a/222 and 122b/222 are minted and distributed to respective one or more of first and second users 308-1 and 308-2. In such a collaborative quest, location monitoring and progress tracking software application 252 resident on each of client devices 140a/140c/240, 140b/140d/240, may be configured to update the progress of the collaborative quest on secure transaction ledger 106/206 or system 110/210/310.

It is noted that, in some implementations a variant NFT distributed to members of an assembly as a reward for assembling may grow scarcer as the number of participants in the assembly increases. For example, when an assembly includes a predetermined threshold number of participants, a “legendary” or limited edition variant NFT may be minted and distributed exclusively to participants in that assembly.

Once a variant NFT is minted and distributed, hardware processor 114 of system 110/210/310 may execute location-based NFT minting and distribution software code 118 to report the details of that minting and distribution on secure transaction ledger 106/206, which may serve as the sole repository of that activity. Moreover, in some implementations reminting and distribution of a variant NFT may cause hardware processor 114 of system 110/210/310 to execute location-based NFT minting and distribution software code 118 to revoke or burn the original NFT on which the variant NFT is based.

According to some implementations, smart contract 360 may include instructions for layering the variant NFT with metadata describing substantially the same information as that reported to secure transaction ledger 106/206. Thus, according to some implementations, hardware processor 114 of system 110/210/310 may execute location-based NFT minting and distribution software code 118 to use smart contract 360 to effectively perform a reminting operation in which it updates the NFT owned by first user 308-1 with a new NFT (i.e., variant NFT 122a/222) that is wrapped or signed with the historical data, resulting in variant NFT 122a/222 including layered metadata that identifies the genesis NFT to which variant NFT 122a/222 is related as a variant, and then a wrapping for the user receiving variant NFT 122a/222. It is noted that, as used in the present application, the terms “wrapped” and “wrapping” refer to the storing of historical ownership data for an NFT with the NFT itself. Consequently, and in contrast to the implementation in which secure transaction ledger 106/206 is the sole reference for NFT transactions, in some implementation the information identifying system 110/210/310, the original creator of the NFT relative to which variant NFT 122a/222 is a variant, first user 308-1, second user 308-2, and all future owner(s) of variant NFT 122a/222 is carried by variant NFT 122a/222 itself rather than having to be obtained from secure transaction ledger 106/206.

It is further noted that, in addition to, or as an alternative to the implementations described above, in some use cases, the present concepts can be adapted to incentivize collaborative creation of NFT assets in addition to incentivizing NFT transactions. For example, in some implementations, ownership of the NFT may enable modification of the NFT asset by the NFT owner. In those implementations, location-based NFT minting and distribution software code 118, when executed by hardware processor 114 of system 110/210/310, or location monitoring and progress tracking software application 252, when executed by hardware processor 244 of client device 140a/140b/140c/140d/240, may be configured to determine the value added to the NFT asset by the modification performed by each present owner, and to weight future royalty distributions to each of those owner(s) as previous NFT owner(s) based at least in part on their estimated contributions to the sales price of each downstream sale of the NFT.

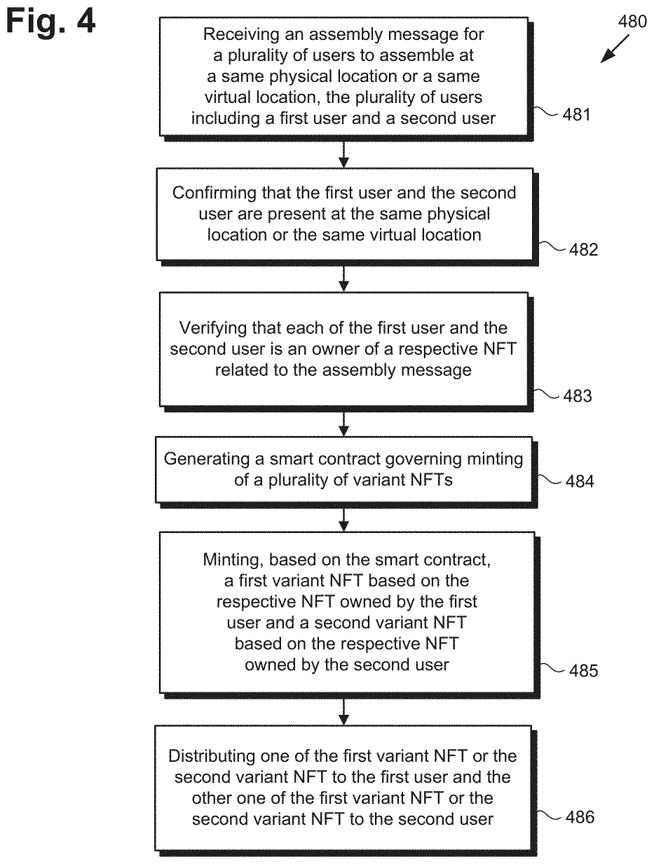

The functionality of system 110/210/310 will be further described below with reference to FIG. 4. FIG. 4 shows flowchart 480 presenting an exemplary method for performing location-based NFT minting and distribution, according to one implementation. With respect to the method outlined by FIG. 4, it is noted that certain details and features have been left out of flowchart 480 in order not to obscure the discussion of the inventive features in the present application.

Referring to FIG. 4 with further reference to FIGS. 1, 2, and 3, flowchart 480 includes receiving an assembly message for a plurality of users to assemble at a same physical location or a same virtual location, the plurality of users including first user 308-1 and second user 308-2 (action 481). As noted above, one or more users who wish to interact with one another and receive an NFT benefit, such as one or both of first and second users 308-1 and 308-2, may transmit an “assembly” message to system 110/210/310. For example, first user 308-1 may utilize client device 140a/140c/240 to transmit such an assembly message and/or second user 308-2 may utilize client device 140b/140d/240 to transmit the assembly message, via communication network 102/202 and network communication links 104/204. Alternatively, in various implementations, the assembly message may be sent by a creator of a respective NFT owned by each of first user 308-1 and second user 308-2 and/or a distributor of at least one of the respective NFTs owned by first user 308-1 or second user 308-2. Thus, the assembly message received in action 481 may be sent by one or more of first user 308-1, second user 308-2, the creator of the respective NFTs owned by each of first user 308-1 and second user 308-2, or a distributor of at least one of the respective NFTs owned by first user 308-1 or second user 308-2. The assembly message may be received, in action 481 by location-based NFT minting and distribution software code 118, executed by hardware processor 114 of system 110/210/310.

Continuing to refer to FIG. 4 in combination with FIGS. 1, 2, and 3, flowchart 480 further includes confirming that first user 308-1 and second user 308-2 are present at the same physical location or the same virtual location (action 482). As noted above, in implementations in which location 120a/320 is a physical location, physical location 120a/320 may be the entire limits of a city, a recreation or resort property, a theme park or other entertainment venue, a hotel, a cruise ship, or the immediate vicinity, e.g., within ten feet or any other predetermined distance, of a physical object or coordinate (e.g., latitude and longitude). As further noted above, in implementations in which location 120b/320 is a virtual location, virtual location 120b/320 may be a virtual venue of an interactive video environment, which, in some implementations, may be configured to provide one or more of a VR, AR, or MR experience to first user 308-1 and second user 308-2. For example, virtual location 120b/320 may be or include a digital representation of a location including persons, fictional characters, objects, and identifiers such as brands and logos, for example, which populate a VR, AR, or MR environment. Such a digital representation may depict a virtual world that can be experienced by any number of users synchronously and persistently, while providing continuity of data such as personal identity, user history, entitlements, possessions, payments, and the like.

As also noted above, in implementations in which location 320 is a real-world, physical location, the concurrent presence of first user 308-1 and second user 308-2 at physical location 120a/320 may be confirmed to an arbitrary level of precision using one or more of GPS data, RFID recognition, NFC recognition, or Bluetooth LE communications, to name a few examples. Alternatively, or in addition, location 320 may include a display showing a QR code that cycles every few seconds, or over any other predetermined time period. In those implementations, and referring to FIGS. 1 and 2 in combination with FIG. 3, first user 308-1 and second user 308-2 could use respective client devices 140a/140c/240 and 140b/140d/240 to scan such a QR code and transmit it to system 110/210/310. As yet another alternative, or in addition, first user 308-1 and second user 308-2 may utilize an authenticator application, such as the Microsoft® Authenticator application for example, which may be supported by client devices 140a/140c/240 and 140b/140d/240, or may be shown on a display present at physical location 120a/320. The authenticator application may provide a pin number that cycles every few seconds, or over any other predetermined time period. In those implementations, first user 308-1 and second user 308-2 could enter that pin number into respective client devices 140a/140c/240 and 140b/140d/240 for transmission to system 110/210/310. Receipt by system 110/210/310 of the same QR code or pin number from each of client devices 140a/140c/240 and 140b/140d/240 verifies the concurrent present of collectors 308a and 308b at physical location 120a/320.

Analogously, in implementations in which location 320 is a virtual location, the concurrent presence of first user 308-1 and second user 308-2 at virtual location 120b/320 may be confirmed using cookies or other tracking tokens employed by virtual location 120b/320. Alternatively, or in addition, virtual location 120b/320 may include a digital representation of a display showing a QR code that cycles every few seconds, or over any other predetermined time period. In those implementations, first user 308-1 and second user 308-2 could use respective client devices 140a/140c/240 and 140b/140d/240 to capture such a QR code and transmit it to system 110/210/310. As yet another alternative, or in addition, first user 308-1 and second user 308-2 may utilize an authenticator application, such as the Microsoft® Authenticator application for example, which may be supported by client devices 140a/140c/240 and 140b/140d/240, or may be shown on a digital representation of a display present at virtual location 120b/320. The authenticator application may provide a pin number that cycles every few seconds, or over any other predetermined time period. In those implementations, first user 308-1 and second user 308-2 could enter that pin number into respective client devices 140a/140c/240 and 140b/140d/240 for transmission to system 110/210/310. Receipt by system 110/210/310 of the same QR code or pin number from each of client devices 140a/140c/240 and 140b/140d/240 verifies the concurrent present of collectors 308a and 308b at virtual location 120b/320. Action 482 may be performed by location-based NFT minting and distribution software code 118, executed by hardware processor 114 of system 110/210/310.

Continuing to refer to FIG. 4 in combination with FIGS. 1, 2, and 3, flowchart 480 further includes verifying that, each of first user 308-1 and second user 308-2 is an owner of a respective NFT related to the assembly message (action 483). By way of example, the assembly message received in action 481 may identify a particular character from a movie franchise. In that exemplary use case, an NFT owned by first and second users 308-1 and 308-2 may qualify as being a related NFT by virtue of being associated with the same character, by being associated with another character from the same movie franchise, or by being associated with another character or movie franchise owned or distributed by the same business entity. Verification that each of the plurality of users is an NFT owner of such an NFT may be performed in a number of different ways. For example, in some use cases, system 110/210/310 may communicate directly with digital wallet 250 of each of first user 308-1 and second user 308-2 to verify that each of first user 308-1 and second user 308-2 is an owner of a qualifying (i.e., related) NFT. Alternatively, or in addition, qualifying NFT ownership by each of first and second users 308-1 and 308-2 may be verified by reference to secure transaction ledger 106/206. Action 483 may be performed by location-based NFT minting and distribution software code 118, executed by hardware processor 114 of system 110/210/310.

Continuing to refer to FIG. 4 in combination with FIGS. 1, 2, and 3, flowchart 480 further includes generating smart contract 360 governing minting of a plurality of variant NFTs (action 484). By way of example, smart contract 360 may link or associate first user 308-1 and second user 308-2 and enable the minting and distribution of variant NFTs. As a specific example, let location 120a/120b/320 be a physical or virtual venue devoted to a particular movie franchise, and let first and second users 308-1 and 308-2 each be owners of a different NFT associated with the movie franchise, for example, NFTs of different characters. In this exemplary use case, smart contract 360 may be generated so as to govern minting variant NFT 122a/222 of the NFT owned by first user 308-1, and to mint variant NFT 122b/222 of the NFT owned by second user 308-2 as rewards for participating in the assembly at location 320a. It is noted that although the exemplary use case described above, variant NFTs 122a/222 and 122b/222 are different variant NFTs, in other implementations, smart contract 360 may be generated so as to specify that variant NFTs 122a/222 and 122b/222 may be substantially identical, variant NFT 122a/222 may be a replication of variant NFT 122b/222, or vice versa. Action 484 may be performed by location-based NFT minting and distribution software code 118, executed by hardware processor 114 of system 110/210/310.

Continuing to refer to FIG. 4 in combination with FIGS. 1, 2, and 3, flowchart 480 further includes minting, based on smart contract 360, a first variant NFT (hereinafter “first variant NFT 122a/222”) based on the respective NFT owned by first user 308-1 and a second variant NFT (hereinafter “second variant NFT 122b/222”) based on the respective NFT owned by second user 308-2 (action 485). Action 485 may be performed by location-based NFT minting and distribution software code 118, executed by hardware processor 114 of system 110/210/310.

As noted above, according to some implementations, smart contract 360 may include instructions for layering first and second variant NFTs 122a/222 and 122b/222 with metadata describing substantially the same information as that reported to secure transaction ledger 106/206. Thus, according to some implementations, hardware processor 114 of system 110/210/310 may execute location-based NFT minting and distribution software code 118 to use smart contract 360 to effectively perform a reminting operation in which it updates the NFT owned by first user 308-1 with a new NFT (e.g., first variant NFT 122a/222) that is wrapped or signed with historical data, resulting in first variant NFT 122a/222 including layered metadata that identifies the genesis NFT to which first variant NFT 122a/222 is related as a variant. Similarly, hardware processor 114 of system 110/210/310 may execute location-based NFT minting and distribution software code 118 to use smart contract 360 to perform a reminting operation in which it updates the NFT owned by second user 308-2 with a new NFT (e.g., second variant NFT 122b/222) that is wrapped or signed with the historical data, resulting in second variant NFT 122b/222 including layered metadata that identifies the genesis NFT to which second variant NFT 122b/222 is related as a variant.

Continuing to refer to FIG. 4 in combination with FIGS. 1, 2, and 3, flowchart 480 further includes distributing one of first variant NFT 122a/222 or second variant NFT 122b/222 to first user 308-1 and the other one of first variant NFT 122a/222 or second variant NFT 122b/222 to second user 308-2 (action 486). As noted above, in some use cases first variant NFT 122a/222 based on the NFT owned by first user 308-1 may be distributed to first user 308-1, while second variant NFT 122b/222 based on the NFT owned by second user 308-2 may be distributed to second user 308-2. However, in other use cases, as depicted in FIG. 3, action 486 may include distributing first variant NFT 122a/222 based on the NFT owned by first user 308-1 to second user 308-2, and distributing second variant NFT 122b/222 based on the NFT owned by second user 308-2 to first user 308-1. Action 486 may be performed by location-based NFT minting and distribution software code 118, executed by hardware processor 114 of system 110/210/310.

It is noted that, in some implementations, the respective one of first variant NFT 122a/222 or the second variant NFT 122b/222 distributed to each of first user 308-1 and second user 308-2 entitles each of first user 308-1 and second user 308-2 to one or more of a VR, AR, or MR experience, which may be the same one or more VR, AR, or MR experience for both of first and second users 308-1 and 308-2, or different one or more VR, AR, or MR experiences for each of first and second users 308-1 and 308-2. For example, in some implementations, physical location 120a/320 may include a theme park attraction and the respective one of first variant NFT 122a/222 and second variant NFT 122b/222 distributed to each of first user 308-1 and second user 308-2 may entitle each of first user 308-1 and second user 308-2 to one or more of a VR, AR, or MR experience at the theme park attraction.

It is further noted that once first and second variant NFTs 122a/222 and 122b/222 are minted and distributed, hardware processor 114 of system 110/210/310 may execute location-based NFT minting and distribution software code 118 to report the details of that minting and distribution on secure transaction ledger 106/206, which may serve as the sole repository of that activity. Moreover, in some implementations reminting and distribution of a variant NFT may cause hardware processor 114 of system 110/210/310 to execute location-based NFT minting and distribution software code 118 to revoke or burn the original NFTs on which first and second variant NFTs 122a/222 and 122b/222 are based.

According to some implementations, smart contract 360 may include instructions for layering the first and second variant NFTs 122a/222 and 122b/222 with metadata describing substantially the same information as that reported to secure transaction ledger 106/206. Thus, first variant NFT 122a/222 may be wrapped to include layered metadata that identifies the genesis NFT to which first variant NFT 122a/222 is related as a variant, and then a wrapping for the user receiving first variant NFT 122a/222. Analogously, second variant NFT 122b/222 may be wrapped to include layered metadata that identifies the genesis NFT to which second variant NFT 122b/222 is related as a variant, and then a wrapping for the user receiving second variant NFT 122b/222. Consequently, and in contrast to the implementation in which secure transaction ledger 106/206 is the sole reference for NFT transactions, in some implementation the information identifying system 110/210/310, the original creator of the NFTs relative to which first and second variant NFTs 122a/222 and 122b/222 are respective variants, the users to which first and second variant NFTs 122a/222 and 122b/222 are distributed in action 486 is carried by first and second variant NFTs 122a/222 and 122b/222 the rather than having to be obtained from secure transaction ledger 106/206.

It is also noted that the actions described by flowchart 480 may advantageously be performed by system 110/210/310 as an automated process. As defined in the present application, the term “automated,” refers to systems and processes that do not require the participation of a human user, such as a human system administrator. For example, although in some implementations a human system administrator may review the performance of the systems and methods disclosed herein, and, in some cases may adjust their performance over time, that human involvement is optional. Thus, in some implementations, the process described by flowchart 480 may be performed under the control of hardware processing components of system 110/210/310.

Thus, the present application discloses systems and methods for performing location-based NFT minting and distribution that address and overcome the deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor and a system memory storing a software code;
the hardware processor configured to execute the software code to:
receive an assembly message for a plurality of users to assemble at a same physical location or a same virtual location, the plurality of users including a first user and a second user;
confirm that the first user and the second user are present at the same physical location or the same virtual location;
verify that each of the first user and the second user is an owner of a respective non-fungible token (NFT) related to the assembly message;
generate a smart contract governing minting of a plurality of variant NFTs;
mint, based on the smart contract, a first variant NFT based on the respective NFT owned by the first user and a second variant NFT based on the respective NFT owned by the second user; and
distribute one of the first variant NFT or the second variant NFT to the first user, and the other one of the first variant NFT or the second variant NFT to the second user.

2. The system of claim 1, wherein distributing distributes the second variant NFT to the first user and the first variant NFT to the second user.

3. The system of claim 1, wherein the same virtual location comprises a virtual venue of an interactive video environment.

4. The system of claim 3, wherein the interactive video environment provides at least one of a virtual reality (VR), augmented reality (AR), or mixed reality (MR) experience to the first user and the second user.

5. The system of claim 1, wherein the same physical location comprises a physical location within one of a theme park, resort property, hotel, or cruise ship.

6. The system of claim 5, wherein the respective one of the first variant NFT or the second variant NFT distributed to each of the first user and the second user entitles each of the first user and the second user to a respective VR, AR, or MR experience.

7. The system of claim 6, wherein the physical location comprises an attraction within the theme park, and wherein the respective one of the first variant NFT or the second variant NFT distributed to each of the first user and the second user entitles each of the first user and the second user to the respective VR, AR, or MR experience at the attraction.

8. The system of claim 6, wherein the VR, AR, or MR experience for the first user is different from the VR, AR, or MR experience for the second user.

9. The system of claim 1, wherein the hardware processor is configured to execute the software code to receive the assembly message from one of the first user, the second user, a creator of at least one of the respective NFTs owned by the first user and the second user, or a distributor of at least one of the respective NFTs owned by the first user and the second user.

10. A method for use by a system including a hardware processor and a system memory storing a software code, the method comprising:
receiving, by the software code executed by the hardware processor, an assembly message for a plurality of users to assemble at a same physical location or a same virtual location, the plurality of users including a first user and a second user;
confirming, by the software code executed by the hardware processor, that the first user and the second user are present at the same physical location or the same virtual location;
verifying, by the software code executed by the hardware processor, that each of the first user and the second user is an owner of a respective non-fungible token (NFT) related to the assembly message;
generating, by the software code executed by the hardware processor, a smart contract governing minting of a plurality of variant NFTs;
minting, by the software code executed by the hardware processor based on the smart contract, a first variant NFT based on the respective NFT owned by the first user and a second variant NFT based on the respective NFT owned by the second user; and
distributing, by the software code executed by the hardware processor, one of the first variant NFT or the second variant NFT to the first, user and the other one of the first variant NFT or the second variant NFT to the second user.

11. The method of claim 10, wherein distributing distributes the second variant NFT to the first user and the first variant NFT to the second user.

12. The method of claim 10, wherein the same virtual location comprises a virtual venue of an interactive video environment.

13. The method of claim 12, wherein the interactive video environment provides at least one of a virtual reality (VR), augmented reality (AR), or mixed reality (MR) experience to the first user and the second user.

14. The method of claim 10, wherein the same physical location comprises a physical location within one of a theme park, resort property, hotel, or cruise ship.

15. The method of claim 14, wherein the respective one of the first variant NFT or the second variant NFT distributed to each of the first user and the second user entitles each of the first user and the second user to a respective VR, AR, or MR experience.

16. The method of claim 15, wherein the physical location comprises an attraction within the theme park, and wherein the respective one of the first variant NFT or the second variant NFT distributed to each of the first user and the second user entitles each of the first user and the second user to the respective VR, AR, or MR experience at the attraction.

17. The method of claim 15, wherein the VR, AR, or MR experience for the first user is different from the VR, AR, or MR experience for the second user.

18. The method of claim 10, wherein the assembly message is received from one of the first user, the second user, a creator of at least one of the respective NFTs owned by the first user and the second user, or a distributor of at least one of the respective NFTs owned by the first user and the second user.

19. A computer-readable non-transitory storage medium having stored thereon a software code, which when executed by a hardware processor, instantiates a method comprising:
receiving an assembly message for a plurality of users to assemble at a same physical location or a same virtual location, the plurality of users including a first user and a second user;
confirming that the first user and the second user are present at the same physical location or the same virtual location;
verifying that each of the first user and the second user is an owner of a respective non-fungible token (NFT) related to the assembly message;
generating a smart contract governing minting of a plurality of variant NFTs;
minting, based on the smart contract, a first variant NFT based on the respective NFT owned by the first user and a second variant NFT based on the respective NFT owned by the second user; and
distributing one of the first variant NFT or the second variant NFT to the first user and the other one of the first variant NFT or the second variant NFT to the second user.

20. The computer-readable non-transitory storage medium of claim 19, wherein the same virtual location comprises a virtual venue of an interactive video environment providing at least one of a virtual reality (VR), augmented reality (AR), or mixed reality (MR) experience to the first user and the second user.
